(19) United States
(12) Patent Application Publication
(10) Pub. No.: US 2023/0286116 A1
(43) Pub. Date: Sep. 14, 2023

(54) MULTI-PURPOSE MULTI-DIRECTIONAL ROTATOR AND WORKING METHOD OF SAME

(71) Applicant: Zhenkun Wang, Cambridge, MA (US)

(72) Inventor: Zhenkun Wang, Cambridge, MA (US)

(21) Appl. No.: 18/098,442

(22) Filed: Jan. 18, 2023

(30) Foreign Application Priority Data
Mar. 12, 2022 (CN) 202220576650.0

(51) Int. Cl. B25B 13/50; B67B 7/16

(52) U.S. Cl. CPC B25B 13/50; B67B 7/16

(57) ABSTRACT

A multi-purpose multi-directional rotator includes: a half-hollowed housing, the interior thereof connected with a fixing pinhole plate, and retractable load rods inserted thereon; the fixing pinhole plate is inserted with a number of fixing pins; the top end of the fixing pin is connected with a spring, and the bottom end thereof is provided with a rubber sheet. The present invention can be used to rotate different shapes of objects through a number of fixing pins inside, and the fixing pins are in close contact with the object by pressing the half-hollowed housing to further squeeze the springs; thereafter, the retractable load rods are pulled out and moved to rotate the rotator, allowing the object to be rotated through the friction force without being limited by the appearance and shape of the object, which adequately meets the rotation needs of some worn and odd-shaped objects.

### CROSS REFERENCE TO RELATED APPLICATION

This application claims the benefits of Chinese application Serial No. 202220576650.0, filed on Mar. 12, 2022, the disclosures of which are incorporated by references herein in its entirety.

### TECHNICAL FIELD

The present invention relates to the technical field of daily necessities, and more particularly to a multi-purpose multi-directional rotator and a working method thereof.

### BACKGROUND

The multi-purpose multi-directional rotator is a tool that can be used to rotate and open bottle caps, screws and other objects that need to be rotated, especially for opening special-shaped or worn objects. There are many multi-functional bottle openers, wrenches, screwdrivers and other tools on the market at present, but it is difficult to rotate some special-shaped or worn objects, while the multi-purpose multi-directional rotator has no specific requirements for the shape of the object to be opened, and has a wide range of uses and is easy to operate, being a rare practical tool.

### SUMMARY

An object of the present invention is to provide a multi-purpose multi-directional rotator, easy to rotate different shapes of objects.

To achieve the above object, the present invention provides the following technical solutions:
a multi-purpose multi-direction rotator includes retractable load rods, a half-hollowed housing, fixing pinhole plate, fixing pins and springs,
where the upper half part of the half-hollowed housing is approximately hemispherical, the lower half part thereof is a cylindrical body, the interior of the cylindric body is in connection with the circular fixing pinhole plate,
where the retractable load rods are fixed on the half-hollowed housing and retractable;
the fixing pinhole plate is inserted with a number of fixing pins;
where the top end of the fixing pin is connected with a spring, and the top end of the spring points to the approximately hemispherical upper half part of the half-hollowed housing; the bottom end of the fixing pin is provided with a rubber sheet adapted to increase friction when the fixing pin is in contact with an object; the insertion direction of the bottom end of the fixing pin points to the center of approximately hemispherical body of the upper half part of the half-hollowed housing.

### BRIEF DESCRIPTION OF THE DRAWINGS

FIG. 1 is a structurally schematic view of a multi-purpose multi-direction rotator of a preferred embodiment of the present invention;

FIGS. 1-1 and 1-2 respectively are a perspective view of the multi-purpose multi-directional rotator of the embodiment of the present invention;

FIG. 1-3 is a top view of the multi-purpose multi-directional rotator of the embodiment of the present invention;

FIG. 1-4 is a bottom view of the multi-purpose multi-directional rotator of the embodiment of the present invention;

FIG. 1-5 is a front view of the multi-purpose multi-directional rotator of the embodiment of the present invention;

FIG. 2 is a structurally schematic view of the multi-purpose multi-directional rotator of the embodiment of the present invention;

FIG. 2-1 is a front view of the multi-purpose multi-directional rotator of the embodiment of the present invention;

FIG. 2-2 is a front perspective view of the multi-purpose multi-directional rotator of the embodiment of the present invention;

FIG. 2-2-1 is an enlarged view of springs of the multi-purpose multi-directional rotator of the embodiment of the present invention;

FIG. 2-3 is a side perspective view of the multi-purpose multi-directional rotator of the embodiment of the present invention;

FIG. 2-4 is a bottom perspective view of the multi-purpose multi-directional rotator of the embodiment of the present invention;

FIG. 2-4-1 is an enlarged view of fixing pins of the multi-purpose multi-directional rotator of the embodiment of the present invention;

FIG. 2-4-2 is an enlarged schematic view of a rubber sheet provided on the front end lend of the fixing pin of the multi-purpose multi-directional rotator of the embodiment of the present invention;

FIG. 3 is a schematic view of a working principle of a multi-purpose multi-directional rotator of a preferred embodiment of the present invention;

FIG. 3-1 is a bottom view of the multi-purpose multi-directional rotator of the embodiment of the present invention after screw entry;

FIG. 3-2 is a perspective view of the multi-purpose multi-directional rotator of the embodiment of the present invention before screw entry;

FIG. 3-2-1 is an enlarged view of the multi-purpose multi-directional rotator of the embodiment of the present invention before the spring is pressed;

FIG. 3-3 is a perspective view of the multi-purpose multi-directional rotator of the embodiment of the present invention after screw entry;

FIG. 3-3-1 is an enlarged view of the multi-purpose multi-directional rotator of the embodiment of the present invention after the spring is pressed;

FIG. 4 is a schematic view of a working method of a multi-purpose multi-directional rotator of a preferred embodiment of the present invention;

FIG. 4-1 is a bottom view of the multi-purpose multi-directional rotator of the embodiment of the present invention after screw entry;

FIG. 4-1-1 shows a normal screw; and

FIG. 4-1-2 shows a worn screw.

### DETAILED DESCRIPTION

The following embodiments will further describe a multi-purpose multi-directional rotator and working method thereof according to the present invention in detail with reference to the accompanying drawings. Apparently, the described embodiments are only some of the embodiments of the present invention, not all of them. Based on the embodiments of the present invention, all other embodiments obtained by persons of ordinary skill in the art without making creative efforts belong to the protection scope of the present invention.

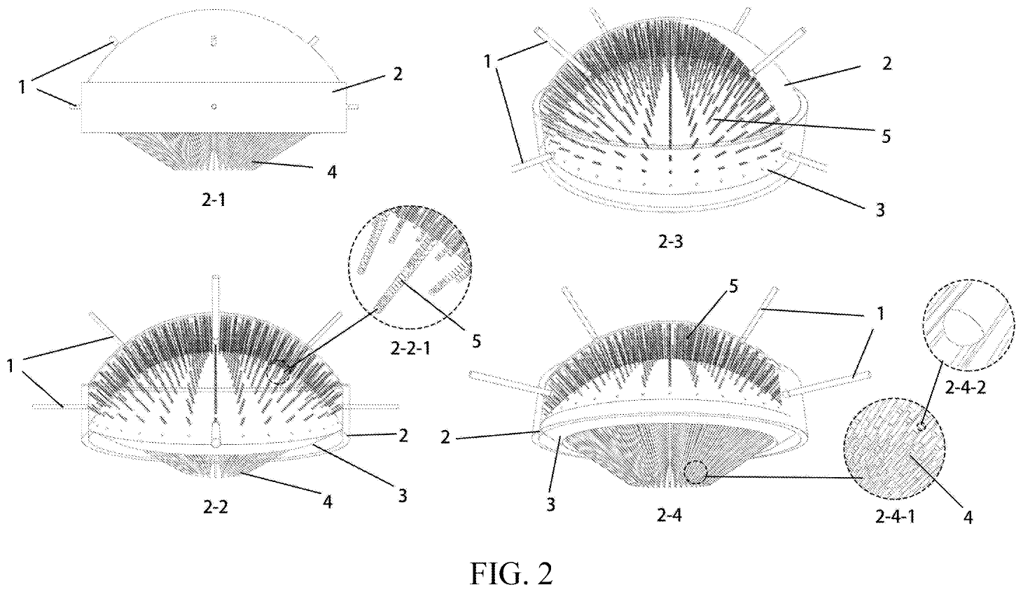

Referring to FIG. 2, a multi-purpose multi-directional rotator, in a preferred embodiment, includes retractable load rods 1, a half-hollowed housing 2, a fixing pinhole plate 3, fixing pins 4, and springs 5.

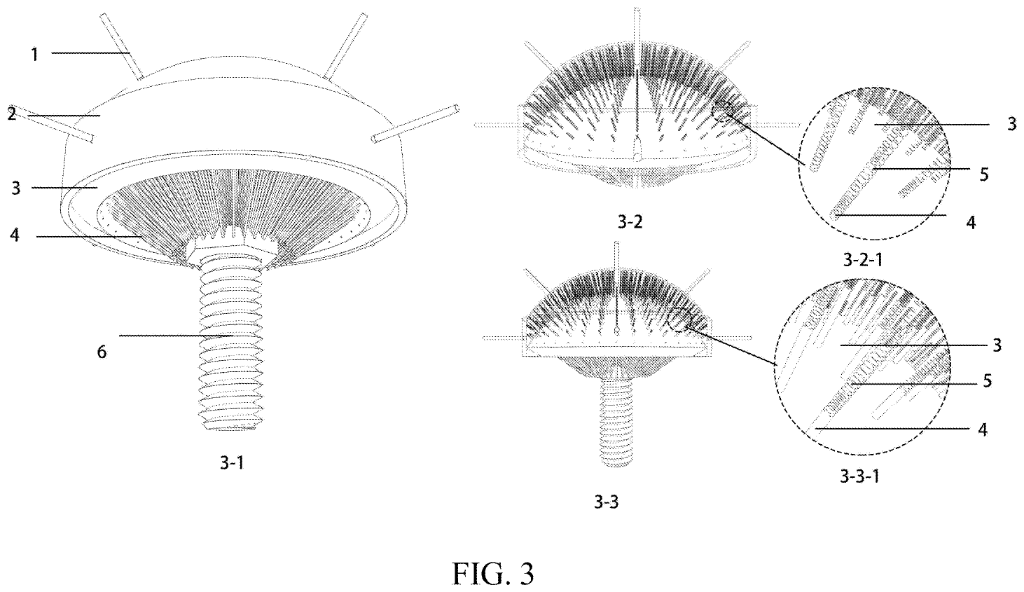

Referring to FIG. 3, the upper half part of the half-hollowed housing 2 of the multi-purpose multi-direction rotator is approximately hemispherical, and the lower half part thereof is a cylindrical body, the interior of which is connected with the circular fixing pinhole plate 3.

The retractable load rods 1 are fixed on the half-hollowed housing 2, and retractable.

The fixing pinhole plate 3 is inserted with a number of the fixing pins 4.

The top end of the fixing pin 4 is connected with the spring 5, and the top end of the spring 5 points to the upper half part of the approximately hemispherical half-hollowed housing 2; the bottom end of the fixing pin 4 has a rubber sheet used to increase the friction when being contact with an object; the insertion direction of the bottom end of the fixing pin 4 points to the center of the approximate hemisphere of the upper half part of the half-hollowed housing 2.

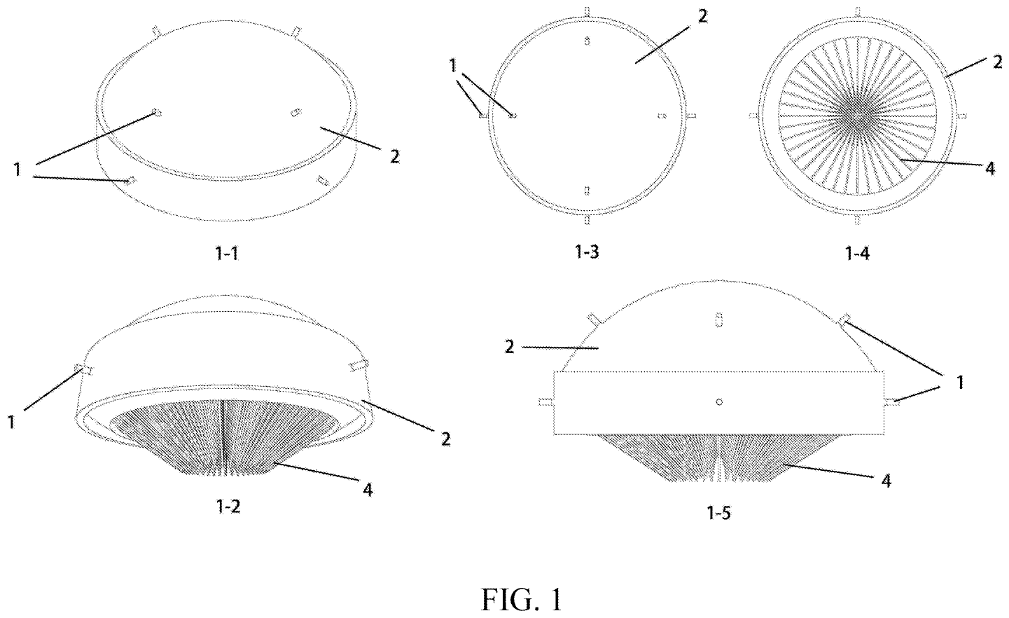

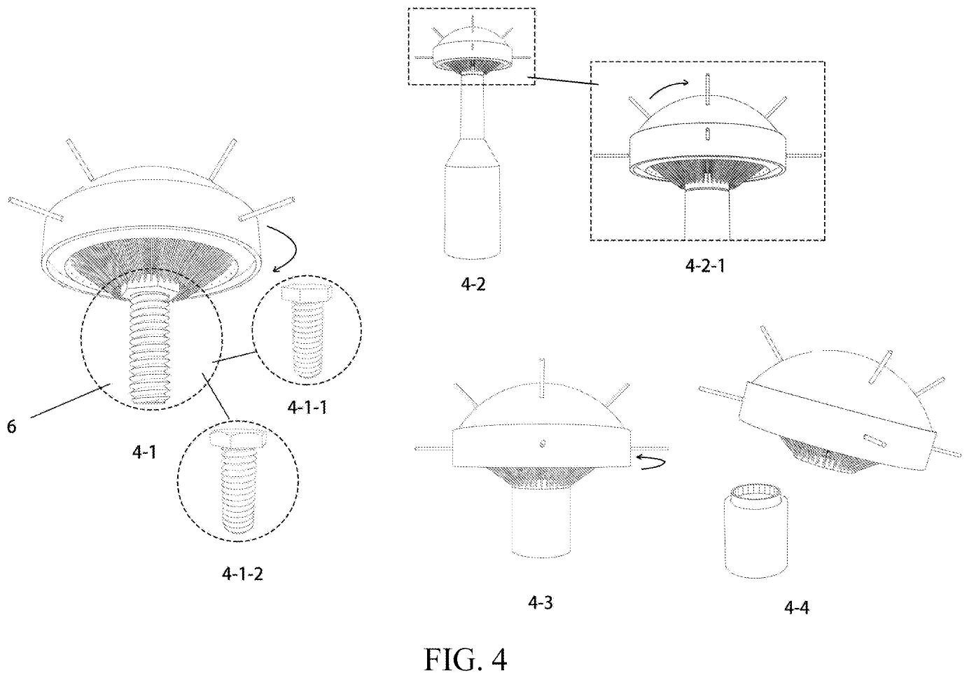

Referring to FIG. 4-1, the multi-purpose multi-directional rotator, in a first preferred embodiment, is first placed on the top of a screw, so that the rubber sheet on the bottom end of each of the fixing pins 4 is attached to the nut. Next (a normal or worn nut is acceptable), the half-hollowed housing is pressed to squeeze the fixing pins 4 to fit tightly on the nut, and the retractable load rods 1 on the half-hollowed housing 2 of the multi-purpose multi-directional rotator are pulled out to make the multi-purpose multi-directional rotator to further cause the screw to be rotated by the friction force generated between the rubber sheets on the bottoms of the fixing pins 4 and the nut in contact therewith. After the use, the fixing pins 4 can be return to the original positions through the springs 5 on the top ends of the fixing pins 4 of the multi-purpose multi-directional rotator. Thereafter, the retractable load rods 1 are returned to their original positions for the convenience of next use.

Referring to FIG. 4-2, the multi-purpose multi-directional rotator, in a second preferred embodiment, is first placed on the top of a bottle cap, so that the rubber sheet on the bottom end of each of the fixing pins 4 is attached to the bottle cap. Next, the half-hollowed housing is pressed to squeeze the fixing pins 4 to fit tightly on the bottle cap, and the retractable load rods 1 on the half-hollowed housing 2 of the multi-purpose multi-directional rotator are pulled out to make the multi-purpose multi-directional rotator rotate to further cause the bottle cap to be rotated by the friction force generated between the rubber sheets on the bottoms of the fixing pins 4 and the bottle cap in contact therewith. After the use, the fixing pins 4 can be return to the original positions through the springs 5 on the top ends of the fixing pins 4 of the multi-purpose multi-directional rotator. Thereafter, the retractable load rods 1 are returned to their original positions for the convenience of next use.

The specific embodiments described herein are intended to be illustrative of the invention only. Those skilled in the art to which the present invention pertains may make various modifications or supplements to the described specific embodiments or replace them in similar ways without departing from the protection scope of the present invention.

What is claimed is:

1. A multi-purpose multi-directional rotator, comprising:
a half-hollowed housing, the interior thereof in connection with a fixing pinhole plate;
retractable loads, perpendicularly inserted in said half-hollowed housing;
said fixing pinhole plate, a number of fixing pins inserted thereon; and
said fixing pins, the top end of each thereof connected with a spring, the bottom end of each thereof provided with a rubber sheet.

2. The rotator according to claim 1, wherein a upper half part of said half-hollowed housing is an approximately hemispherical body, and lower half part thereof is a cylindrical body, with the interior of said cylindrical body being in connection with said circular fixing pinhole plate.

3. The rotator according to claim 1, wherein said retractable load rods are fixed on said half-hollowed housing, and can be pulled out and retracted.

4. The rotator according to claim 1, wherein said fixing pinhole plate is inserted with a number of said fixing pins.

5. The rotator according to claim 1, wherein the top end of said fixing pin is connected with said spring, and the top end of said spring points to the approximately hemispherical upper part of said half-hollowed housing; the bottom end of said fixing pin is provided with a rubber sheet adapted to increase friction when in contact with an object; a insertion direction of said fixing pin points to the center of said approximately hemispherical body of the upper half part of said half-hollowed housing.

6. A working method of the multi-purpose multi-directional rotator according to claim 1, comprising:
placing said multi-purpose multi-directional rotator on the top of an object to be rotated, allowing said rubbers on the bottom ends of said fixing pins to be attached on said object, and pressing said half-hollowed housing to further squeeze said fixing pins to tightly fit on said object;
pulling out said retractable load rods need to be used on said multi-purpose multi-directional rotator to make said multi-purpose multi-directional rotator rotate to further rotate said object through the friction generated between the bottom ends of said fixing pins and said object; and
returning said fixing pins to their original positions through said springs on the top ends of said fixing pins of said multi-purpose multi-directional rotator, and retracting said retractable load rods to their original positions after use for the convenience of next use.

7. A working method of the multi-purpose multi-directional rotator according to claim 2, comprising:
placing said multi-purpose multi-directional rotator on the top of an object to be rotated, allowing said rubbers on the bottom ends of said fixing pins to be attached on said object, and pressing said half-hollowed housing to further squeeze said fixing pins to tightly fit on said object;
pulling out said retractable load rods need to be used on said multi-purpose multi-directional rotator to make said multi-purpose multi-directional rotator rotate to further rotate said object through the friction generated between the bottom ends of said fixing pins and said object; and
returning said fixing pins to their original positions through said springs on the top ends of said fixing pins of said multi-purpose multi-directional rotator, and retracting said retractable load rods to their original positions after use for the convenience of next use.

8. A working method of the multi-purpose multi-directional rotator according to claim 3, comprising:
placing said multi-purpose multi-directional rotator on the top of an object to be rotated, allowing said rubbers on the bottom ends of said fixing pins to be attached on said object, and pressing said half-hollowed housing to further squeeze said fixing pins to tightly fit on said object;
pulling out said retractable load rods need to be used on said multi-purpose multi-directional rotator to make said multi-purpose multi-directional rotator rotate to further rotate said object through the friction generated between the bottom ends of said fixing pins and said object; and
returning said fixing pins to their original positions through said springs on the top ends of said fixing pins of said multi-purpose multi-directional rotator, and retracting said retractable load rods to their original positions after use for the convenience of next use.

9. A working method of the multi-purpose multi-directional rotator according to claim 4, comprising:
placing said multi-purpose multi-directional rotator on the top of an object to be rotated, allowing said rubbers on the bottom ends of said fixing pins to be attached on said object, and pressing said half-hollowed housing to further squeeze said fixing pins to tightly fit on said object;
pulling out said retractable load rods need to be used on said multi-purpose multi-directional rotator to make said multi-purpose multi-directional rotator rotate to further rotate said object through the friction generated between the bottom ends of said fixing pins and said object; and
returning said fixing pins to their original positions through said springs on the top ends of said fixing pins of said multi-purpose multi-directional rotator, and retracting said retractable load rods to their original positions after use for the convenience of next use.

10. A working method of the multi-purpose multi-directional rotator according to claim 5, comprising:
placing said multi-purpose multi-directional rotator on the top of an object to be rotated, allowing said rubbers on the bottom ends of said fixing pins to be attached on said object, and pressing said half-hollowed housing to further squeeze said fixing pins to tightly fit on said object;
pulling out said retractable load rods need to be used on said multi-purpose multi-directional rotator to make said multi-purpose multi-directional rotator rotate to further rotate said object through the friction generated between the bottom ends of said fixing pins and said object; and
returning said fixing pins to their original positions through said springs on the top ends of said fixing pins of said multi-purpose multi-directional rotator, and retracting said retractable load rods to their original positions after use for the convenience of next use.
